(19) United States
(12) Patent Application Publication
(10) Pub. No.: US 2007/0221023 A1
(43) Pub. Date: Sep. 27, 2007

(54) Method and Combined Machining Apparatus for Machining Conductive Workpiece

(75) Inventors: Shinichi Yoshida, Kanagawa (JP); Yuzo Dohi, Kanagawa (JP)

Correspondence Address: MCDERMOTT WILL & EMERY LLP, 18191 VON KARMAN AVE., SUITE 500, IRVINE, CA, 92612-7108, US

(73) Assignee: SODICK CO., LTD.

(21) Appl. No.: 11/578,349

(22) PCT Filed: Oct. 18, 2005
(86) PCT No.: PCT/JP05/19452

§ 371 Date: Oct. 12, 2006

(30) Foreign Application Priority Data
Oct. 18, 2004 (JP) 2004-302976

(51) Int. Cl. B24C 3/00; B23P 9/00

(52) U.S. Cl. 83/53; 219/69.11

(57) ABSTRACT

A combined machining apparatus (2) includes a work stand (18) for fixing a workpiece (4), a jet nozzle (6) for jetting high pressure water towards the workpiece, a wire electrode (8), and upper and lower wire guides for supporting the wire electrode perpendicularly. The jet nozzle and upper wire guide are capable of being moved between an operating position where the workpiece can be cut and a respective refuge position separated from the operating position. The workpiece fixed to a work stand is cut to a desired shape by water jet cutting, and the cut surface is then finished to desired high machining accuracy using wire electric discharge machining with the workpiece still fixed to the work stand.

### TECHNICAL FIELD

The present invention relates to a wire electric discharge machining method for machining a workpiece by generating electric discharge in a work gap formed between a wire electrode and a conductive workpiece. The present invention further relates to a water jet cutting method for cutting a workpiece using high pressure water jetted from a jet nozzle.

### BACKGROUND ART

The wire electric discharge machining method is one method capable of cutting a conductive workpiece into complex shapes. It is even possible to cut a workpiece made from a material that is difficult to cut, such as cemented carbide. The workpiece is machined using electric discharge generated in the work gap without being brought into contact with a wire electrode as a tool. Accordingly, an extremely high machining accuracy, for example, a shape accuracy of a few μm or less and a surface roughness of a few μmRz or less, is realized. In the following, dimensional accuracy, shape accuracy and surface roughness will be collectively called machining accuracy. Shape accuracy is the degree of geometric deviation from a required shape, and includes, for example, straightness, flatness, perpendicularity, parallelism and roundness, etc. The maximum rate of wire electric discharge machining in the case of using a galvanized brass wire electrode of φ0.3 mm is 250 mm²/min-550 mm²/min. If electrical energy supplied to the work gap is made large, machining rate increases. However, the electrical energy must be within a range in which the wire electrode does not fuse, and a larger electrical energy reduces machining accuracy. Generally, in order to balance machining accuracy and machining rate, wire electric discharge machining is divided into a number of steps. Firstly, the wire electrode is moved on a specified trajectory, and the workpiece is cut to a rough required shape with a large electrical energy. Rough machining is called first cut. At the time first cut is completed, surplus material that must be removed remains on the cut surface, and the cut surface does not have the required roughness. Next, the cut surface is finished at a required machining accuracy using a small electrical energy. Finishing is called second cut. During second cut, the wire electrode is made to move on an offset trajectory so that the size of the work gap becomes smaller. In this manner, the surplus material is removed to obtain a required dimensional accuracy, and the roughness of the cut surface is reduced to a required value. Second cut includes a number of steps to gradually achieve the required surface roughness. Normally, a smaller electrical energy is used for each subsequent step, and electric discharge is generated in a work gap of smaller size.

As a method for cutting a metal workpiece, laser machining, ion beam machining, and waterjet cutting are known. These methods achieve higher machining accuracy than electric discharge machining, but are used when high machining accuracy is not required. Abrasive waterjet cutting, where a workpiece is cut by jetting high pressure water mixed with abrasive grains from a jet nozzle, can remove material at a rate of about 10 times that of wire electric discharge machining.

Japanese patent publication No. 3137729 discloses a method of cutting location within a workpiece that require high machining accuracy using wire electric discharge machining, and cuts other location using laser machining or waterjet cutting.

Japanese patent publication No. 2928323 discloses a system where a wire electric discharge machining apparatus, laser machining apparatus and water jet cutting apparatus are provided within a factory, and a workpiece is moved about using a pallet.

Japanese patent publication No. 4-343671 discloses a method of roughly forming a recess in a workpiece by scanning the workpiece surface using a high-speed flow of liquid mixed with abrasive grains. This publication described that precision is required, the formed recess is finished using cutting, grinding, electric discharge machining, laser machining, etc.

U.S. Pat. No. 6,800,829 discloses a combined machining apparatus for repairing an air-cooled component. Part of the component is removed by water jet cutting, and a cooling hole is formed in the component by electric discharge machining.

An object of the present invention is to provide a method for minimizing time for cutting a conductive workpiece into a desired shape and finishing to high machining accuracy.

Another object of the present invention is to provide a method for machining a conductive workpiece making maximum use of the advantages of both water jet cutting and wire electrode discharge machining.

A further object of the present invention is to provide a simplified combined machining apparatus for minimizing time for cutting a conductive workpiece into a desired shape and finishing to high machining accuracy.

### DISCLOSURE OF THE INVENTION

With the method of the present invention, a conductive workpiece fixed to a work stand is cut to a desired shape by water jet cutting, and the cut surface is then finished to desired high machining accuracy using wire electric discharge machining with the workpiece still fixed to the work stand.

Accordingly, the time from completion of water jet cutting to commencement of wire electric discharge machining is shortened.

According to the present invention, a combined machining apparatus for performing water jet cutting and wire cut electric discharge machining includes:

a work stand (18) for fixing a workpiece (4),

a jet nozzle (6) capable of being moved between an operating position where the workpiece can be cut and a refuge position separated from the operating position, for jetting high pressure water towards the workpiece,

a wire electrode (8), and

upper and lower wire guides for supporting the wire electrode perpendicularly.

The upper wire guide can move between the operating position and the refuge position separated from the operating position.

Preferably, the combined machining apparatus includes a work tank (26) for holding machining fluid, and the work tank also functions as a catcher tank.

Other novel features of the invention will be described in the following description.

### BRIEF DESCRIPTION OF THE DRAWINGS

FIG. 1 is a front elevation illustrating a combined machining apparatus of the present invention with a jet nozzle facing the workpiece.

FIG. 2 is a front elevation illustrating the combined machining apparatus of FIG. 1, with a wire electrode suspended perpendicularly close to the workpiece.

FIG. 3 is a block diagram illustrating a control system belonging to the combined machining apparatus of FIG. 1.

FIG. 4 is a circuit diagram illustrating a fluid supply system belonging to the combined machining apparatus of FIG. 1.

### DETAILED DESCRIPTION OF THE PREFERRED EMBODIMENTS

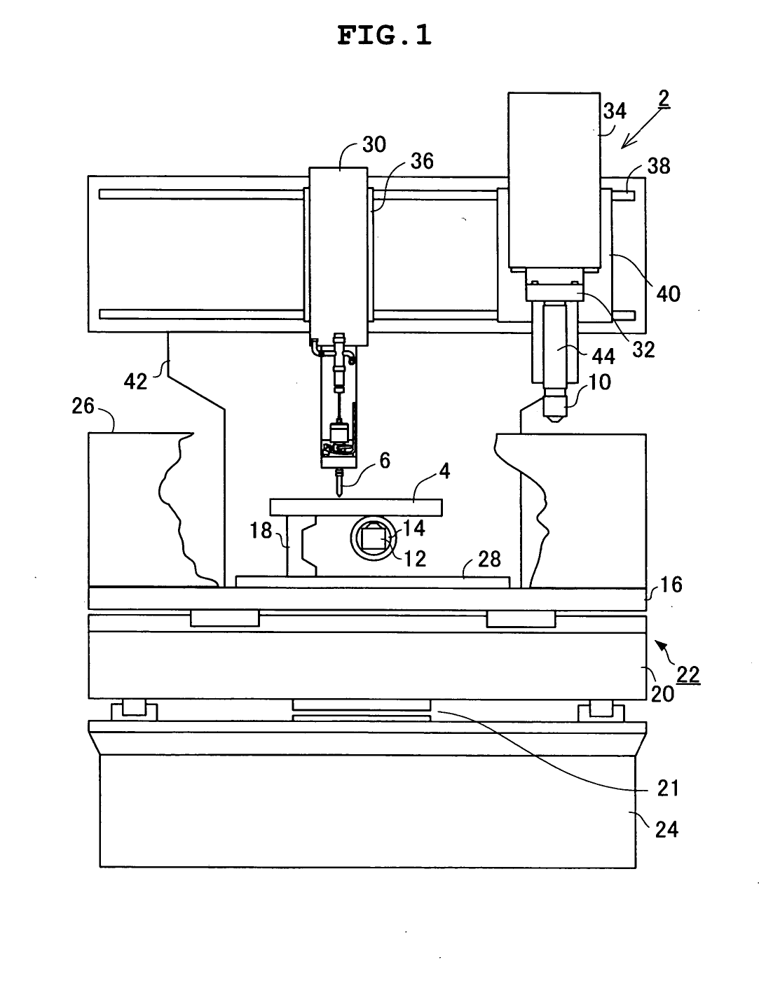

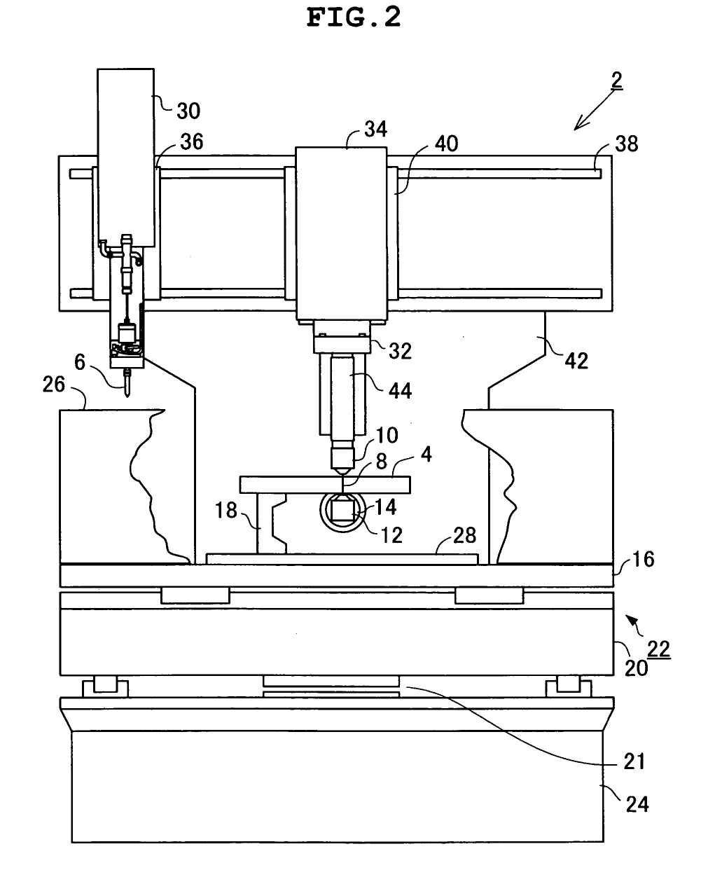

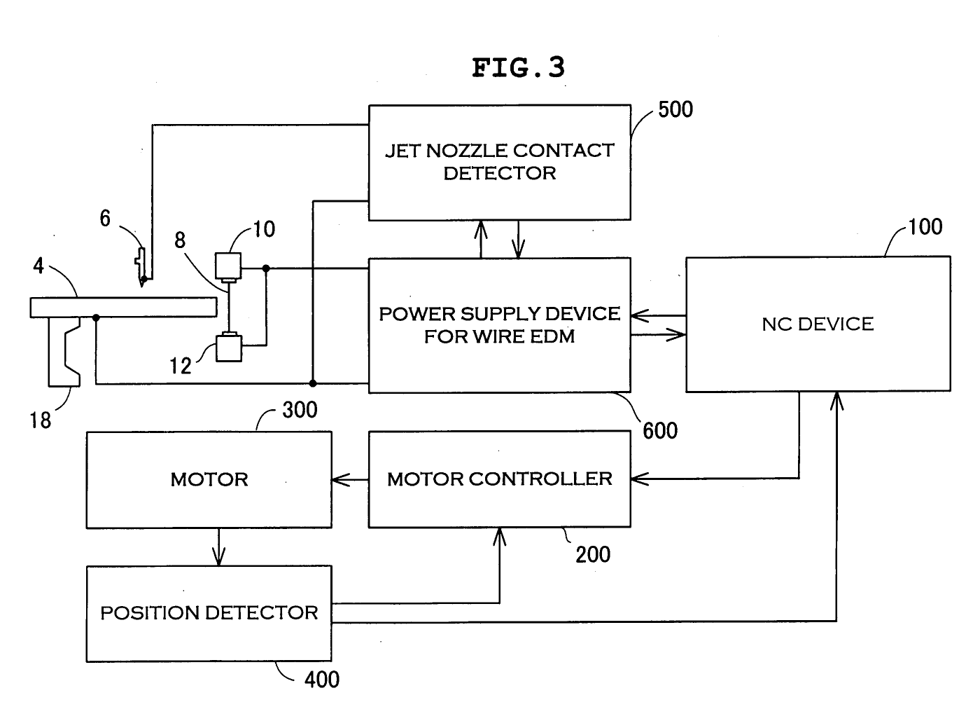

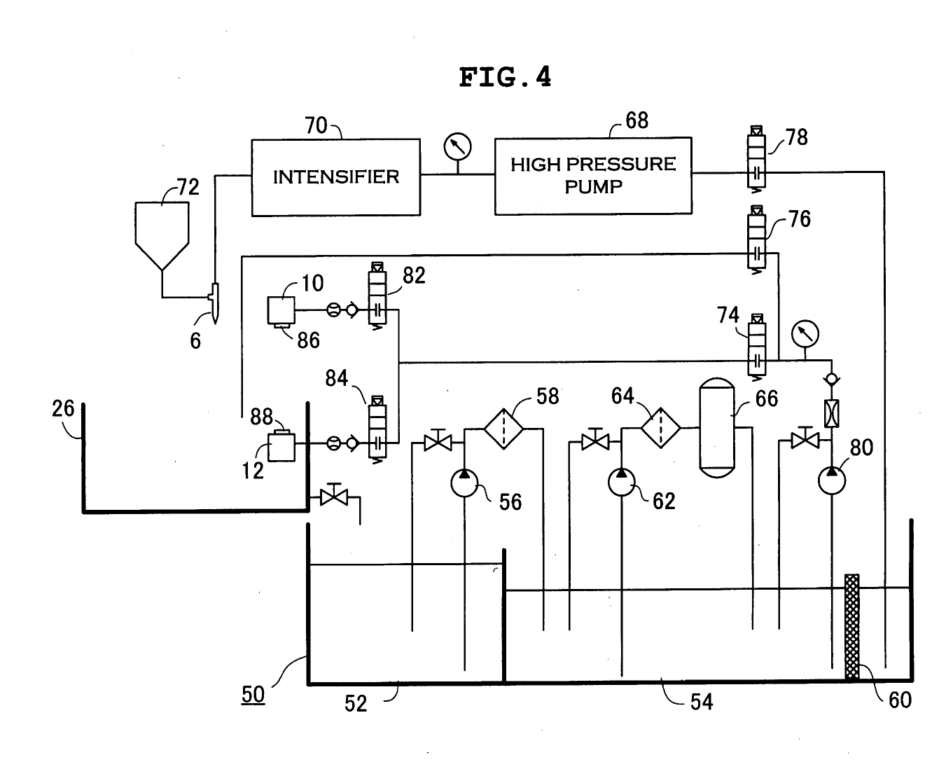

A combined machining apparatus of the present invention will now be described with reference to FIG. 1, FIG. 2, FIG. 3 and FIG. 4.

The combined machining apparatus 2 includes a jet nozzle 6, a wire electrode 8, and a movement unit 22 for moving the wire electrode 8 or the jet nozzle 6 relative to the workpiece 4. The jet nozzle 6 can jet high-pressure water downwards towards a workpiece 4 for water jet cutting. The wire electrode 8 is suspended perpendicularly close to the workpiece 4, for wire electric machining. Upper and lower wire guide assemblies 10 and 12 are opposite each other either side of the workpiece 8, and house upper and lower wire guides (not shown) for perpendicularly supporting the wire electrode 8. The lower guide assembly 12 is attached to a tip end of a lower arm 14. By using well-known means, the wire electrode 8 is supplied from a bobbin to the work gap, and further fed through the lower arm 14 to an appropriate recovery box. The workpiece 4 is fixed to a work stand 18 which is provided on a table 16. The table 16 is mounted on a saddle 20, and is moveable in the direction of the horizontal X axis by a linear motor (not shown). The saddle 20 is mounted on a bed 24, and is capable of being moved in the direction of the Y axis orthogonal to the X axis by a linear motor 21. The table 16, saddle 20 and linear motors for driving these components constitute the movement unit 22. The saddle 20 is mounted on the bed 24. Four wall surfaces surrounding the workpiece 4 are provided on the table 16, forming a work tank 26 that holds machining fluid. The lower arm 14 passes through the wall of the work tank 26 in a watertight manner, and is supported on a column 42. The column 42 is erected on the bed 24. The work tank 26 achieves a function for immersing the workpiece 4 in dielectric fluid, and also a function as a splashguard. The work tank 26 filled with machining fluid has a function of a catcher tank for catching a high-pressure water jet. A mat material 28 that is not damaged even if the high-pressure water jet is received is provided above the table 16. The movement unit 22 includes a machining head 30 and a transmission mechanism (not shown). The machining head 30 is moveable in the direction of Z axis perpendicular to the horizontal XY plane. The jet nozzle 6 is perpendicularly attached to the machining head 30. The transmission mechanism is comprised of a servo motor for driving the machining head 30, a ball screw and a nut. The movement unit 22 further includes a taper cutting device 32. The taper cutting device 32 includes a moving body moving in the direction of a U axis parallel to the X axis, a moving body moving in the direction of a V axis parallel to the Y axis, and a transmission mechanism for each moving body. Each transmission mechanism is comprised of a servo motor, a ball screw and a nut. The wire electrode 8 between the upper and lower wire guides can be inclined with respect to the workpiece by the taper cutting device 32. The movement unit 22 includes a machining head 34 and a transmission mechanism for that head. An automatic wire threader 44 for feeding the wire electrode 8 between the upper and lower wire guides is provided in the machining head 34. An upper guide assembly 10 is attached to the machining head 34 using an appropriate upper arm and the taper cutting device 32. The transmission mechanism is comprised of a servo motor for driving the machining head 34, a ball screw and a nut. A well-known tilting device for tilting the jet nozzle 6 to vary the direction in which the high pressure water is jetted, may be provided on the machining head 30.

The machining head 30 is fixed to a slider 36, and the machining head 34 is fixed to a slider 40. The sliders 36 and 40 can reciprocate in a direction parallel to the X axis on a guide rail 38. The movement unit 22 comprises the sliders 36 and 40, and linear motors (not shown) for driving these sliders. The guide rail 38 is provided on an upper front surface of the column 42. In this way, the jet nozzle 6 can be moved between an operating position where the workpiece 4 can be cut and a refuge position separated from the operating position. In FIG. 1 and FIG. 2, the operating position is substantially in the center of the combined machining apparatus 2, above the workpiece 4. The refuge position for the jet nozzle 6 is separated from the operating position by such an extent that it does not hinder the wire electric discharge machining. The upper wire guide can move between the operating position and another refuge position separated from the operating position. The refuge position for the upper wire guide is separated from the operating position by such an extent that it does not hinder the waterjet cutting. The jet nozzle 6 and the upper wire guide share the operating position. The above-described structure has the advantage that it is possible to make the size of the table 16 comparatively small.

A control system belonging to the combined machining apparatus 2 will now be described with reference to FIG. 3. An NC device 100 and a motor controller 200 control the movement unit 22 based on machining data. Machining data is, for example, NC data obtained by decoding of an NC program. The NC program is created in accordance with information relating to a shape to be formed in a workpiece 4. Information relating to shape includes, for example, required dimensional accuracy and surface roughness. The NC data includes information relating to commands, information relating to trajectories of the jet nozzle 6 and the wire electrode 8, information relating to a plurality of positions on the trajectories, and information relating to correction amounts and machining conditions, etc. The motor 300 in FIG. 3 collectively represents all actuators for moving the moving bodies. The position detector 400 collectively represents all position detectors provided on the moving bodies or motors. The position detector 400 is a linear encoder comprising an optical reader and a scale. A rotary encoder may be provided on a rotary servo motor. Detection signals from the position detector 400 are fed back to the motor controller 200, and also supplied to the NC device 100. A jet nozzle contact detector 500 is means for electrically detecting contact between the jet nozzle 6 and the workpiece 4. At least part of the jet nozzle 6 is comprised of conductive material, and electrically connected to a power supply inside the contact detector 500. The contact detector 500 receives command signals from the NC device 100, and applies a voltage to the jet nozzle 6 and the workpiece 4. Detection signals from the contact detector 500 are supplied to the NC device 100. A power supply 600 for the wire electric discharge machining supplies a power pulse to cause electric discharge in a work gap formed between the traveling wire electrode 8 and the workpiece 4. The NC device 100 sends command signals to the power supply 600 based on the settings of machining conditions. The power supply 600 has a contact detector for electrically detecting contact between the wire electrode 8 and the workpiece 4. The NC device 100 receives detection signals from the contact detector, and locates a reference position for the workpiece 4.

A fluid supply system belonging to the combined machining apparatus 2 will now be described with reference to FIG. 4. The fluid supply system is controlled by the NC device 100 in FIG. 3. Machining fluid used in wire electric discharge machining is water-based dielectric fluid. Machining fluid used in waterjet cutting is water mixed with abrasive grains of the same particle size at a certain percentage. A storage tank 50 has a dirty fluid tank 52 for storing machining fluid that has been used, and a clean fluid tank 54 for storing machining fluid that has been purified. Machining fluid discharged from the work tank 26 is collected in the dirty fluid tank 52. Machining swarf with high specific gravity is deposited at the bottom of the dirty fluid tank 52. Machining fluid in the dirty fluid tank 52 is fed by a pump 56 to the clean fluid tank 54 via a filter 58. The filter 58 removes machining swarf and abrasive grains to purify the machining fluid. The clean fluid tank 54 is partitioned by a filter 60 that will pass neither small sized machining swarf or abrasive grains. A circulation pipeline having a pump 62, a filter 64 and an ion exchange resin tank 66 is provided in the clean fluid tank 54. Resistivity of the machining fluid is kept at a value required for wire electric discharge machining by the ion exchange resin tank 66. Machining fluid inside the clean fluid tank 54 is supplied through a solenoid valve 78, high pressure pump 68 and pressure intensifier 70 to the jet nozzle 6. The high pressure pump 68 and pressure intensifier 70 can generate high pressure water at 200 MPa-450 MPa. An optimum amount of abrasive grains are supplied from a hopper 72 to a mixing chamber inside the jet nozzle 6. In order to fill the work tank 26 with machining fluid, machining fluid inside the clean fluid tank 54 is fed by a pump 80 through a solenoid valve 76 to the work tank 26. During wire electric discharge machining, the solenoid valves 76 and 78 are closed, and machining fluid is supplied by the pump 80 from the clean fluid tank 54 through the solenoid valve 74, and guide assemblies 10 and 12 to the work gap. The upper and lower guide assemblies 10 and 12 are respectively provided with flushing nozzles 86 and 88 for jetting machining fluid towards the work gap. Solenoid valves 82 and 84 are provided in order to stop a flushing from one of the flushing nozzles 86 and 88.

A method of machining a conductive workpiece 4 according to the present invention will now be described.

First of all, the workpiece 4 is correctly located within the XY plane and in the Z axis direction. After that, the workpiece 4 is cut into a desired shape by waterjet cutting.

An operator firstly fixes the workpiece 4 to the work stand 18 using an appropriate fastening device. The workpiece 4 has a locating hole used for locating. The operator then moves the jet nozzle 6 from the refuge position to the operating position, and an NC program for locating is decoded in the NC device 100. The NC device 100 sends movement commands representing position and velocity to the motor controller 200, and operates the jet nozzle contact detector 500. The NC device 100 moves the jet nozzle 6 in four directions of X+, X−, Y+ and Y− within the locating hole in accordance with the NC program for locating. If the contact detector 500 detects contact between the jet nozzle 6 side surface and the workpiece 4 movement of the table 16 and the saddle 20 is immediately stopped. The contact position is stored in the NC device 100. The NC device 100 holds outer diameter data for the jet nozzle 6, and determines the center of the locating hole to be a reference position based on a plurality of contact positions. It is also possible to set the reference position by obtaining end surfaces of the workpiece 4 instead of the locating hole. The tip of the jet nozzle 6 contacts the upper surface of the workpiece 4, and the upper surface of the workpiece 4 is located. The jet nozzle 6 is positioned a specified distance above the upper surface of the workpiece 4 by raising the machining head 30. The position detector 400 detects the position of the jet nozzle 6, and the NC device 100 determines the detected position to be a reference position for the Z axis direction. The specified distance is a few tens of mm, and the reference position is correctly determined in units of 1 μm. In this manner, locating of the workpiece 4 is completed. The operator then fills the work tank 26 with machining fluid and executes an NC program. The NC device 100 sequentially decodes the NC program to advance waterjet cutting under set machining conditions. The motor controller 200 receives movement commands calculated by the NC device 100. The jet nozzle 6 is positioned at a machining start point, and a high pressure water jet at 200 MPa or greater mixed with abrasive grains is jetted towards the workpiece 4 from the jet nozzle 6. The jet nozzle 6 is moved on a specified trajectory relative to the workpiece 4. In this way, a desired shape is roughly cut in the workpiece 4 at a machining rate of 10 times that with wire electric discharge machining. If cutting of the desired shape is completed, the operator moves the jet nozzle 6 from the operating position to the refuge position. When the cut shape includes a through hole, the operator removes sections from in side the workpiece 4 corresponding to the through hole.

Next, in order to finish the cut surface to a desired machining accuracy, the workpiece 4 is subjected to wire electric discharge machining while still fixed to the work stand 18. The operator does not need to fix and locate the workpiece 4 again in preparation for finishing. Also, since the environment around the workpiece 4 does not vary greatly, high machining accuracy is ensured. The operator moves the upper wire guide in the upper guide assembly 10 from the refuge position to the operating position. The wire electrode 8 is passed through the upper wire guide, the through hole formed in the workpiece 4, and the lower wire guide by the automatic wire threader 44. If the operator executes an NC program for wire electric discharge machining, the NC device 100 sequentially decodes the NC program to advance wire electric discharge machining under set machining conditions. The wire electrode 8 travels along a transport path, and machining fluid is jetted from the flushing nozzles 86 and 88 towards the workpiece 4. The power supply 600 supplies a power pulse to the work gap in accordance with machining conditions. The wire electrode 8 suspended between the pair of wire guides is positioned at the same machining start point relative to the workpiece 4 as for waterjet cutting. The wire electrode 8 is moved towards the cut surface, and moved further along the cut surface on the specified trajectory. Wire electric discharge machining includes a number of steps which vary set conditions depending on required accuracy. In later steps, a smaller energy power pulse is applied to the work gap. In the final step, a small power pulse that makes it possible to reduce surface roughness of the cut surface to a required value is used. In this manner, with high machining accuracy of, for example, a shape accuracy of a few μm or less and a surface roughness of a few μmRz or less, that is not possible with waterjet cutting, is realized.

1. A method of machining a conductive workpiece, comprising the steps of:
cutting the workpiece fixed to a work stand to a desired shape by water jet cutting;
finishing the cut surface to desired high machining accuracy using wire electric discharge machining with the workpiece still fixed to the work stand.

2. A combined machining apparatus for performing water jet cutting and wire cut electric discharge machining, comprising:
a work stand for fixing a workpiece;
a jet nozzle capable of being moved between an operating position where the workpiece can be cut and a refuge position separated from the operating position, for jetting high pressure water towards the workpiece;
a wire electrode; and
upper and lower wire guides for supporting the wire electrode perpendicularly;
wherein the upper wire guide can move between the operating position and a refuge position separated from the operating position.

3. The combined machining apparatus of claim 2 further comprising a table on which the work stand is provided and is moveable in an XY plane.

4. The combined machining apparatus of claim 2 further comprising a work tank which surrounds the workpiece and holds machining fluid.

5. The combined machining apparatus of claim 4 further comprising a dirty fluid tank for collecting machining fluid discharged from the work tank, a purifying device for purifying machining fluid in the dirty fluid tank, a clean fluid tank for storing machining fluid that has been purified, a high pressure pump for supplying machining fluid in the clean fluid tank to the jet nozzle, and an ion exchange resin tank for ion exchanging machining fluid in the clean fluid tank.
